(19) United States
(12) Patent Application Publication
(10) Pub. No.: US 2011/0279041 A1
(43) Pub. Date: Nov. 17, 2011

(54) ILLUMINATION APPARATUS AND BRIGHTNESS ADJUSTING METHOD THEREOF

(75) Inventors: LUNG DAI, Tu-Cheng (TW); SHAO-LIN ZHANG, Shenzhen City (CN)

(73) Assignees: HON HAI PRECISION INDUSTRY CO., LTD., Tu-Cheng (TW); HONG FU JIN PRECISION INDUSTRY(ShenZhen) CO., LTD., Shenzhen City (CN)

(21) Appl. No.: 13/008,036

(22) Filed: Jan. 18, 2011

(30) Foreign Application Priority Data
May 12, 2010 (CN) 201010169093.2

(51) Int. Cl. H05B 37/02

(52) U.S. Cl. 315/152; 315/158

(57) ABSTRACT

An illumination apparatus includes a power supply, a detection unit, a PWM unit, a constant current circuit and an illumination unit. The detection unit detects the brightness of the ambient light and generates a detecting signal according to the brightness of the ambient light. The PWM unit outputs a pulse voltage according to the detecting signal. The constant current circuit supplies a constant current to the illumination unit. The illumination unit emits light according to the pulse voltage. When the brightness of the ambient light is increased, the magnitude of the detecting signal increases and the duty cycle of the pulse voltage increases. The luminous intensity of the illumination apparatus increases. When the brightness of the ambient light is decreased, the magnitude of the detecting signal decreases and the duty cycle of the pulse voltage decreases. The luminous intensity of the illumination apparatus decreases.

### BACKGROUND

1. Technical Field

The present disclosure relates to illumination apparatuses; and particularly to a brightness adjusting method used by an illumination apparatus.

2. Description of Related Art

Light emitting diodes (LEDs) are widely used in various electronic devices, such as a backlight module of a liquid crystal display (LCD). However, in some LCDs, the LEDs often emit light according to a predetermined current supplied by a constant current terminal, such that the brightness of the LEDs maintain a constant brightness regardless of ambient illumination change. This is an inconvenience.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is a block diagram of an illumination apparatus in accordance with one exemplary embodiment.

FIG. 2 is a circuit diagram of the illumination apparatus of FIG. 1 in accordance with the exemplary embodiment.

FIG. 3 is a flow chart of a brightness adjusting method in accordance with the exemplary embodiment.

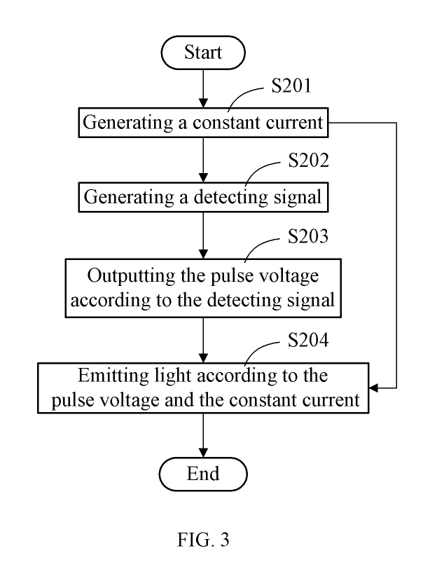

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

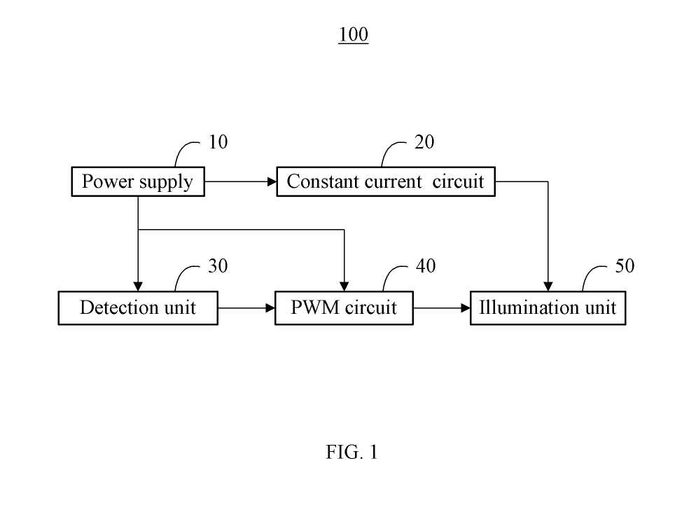

Referring to FIG. 1, an illumination apparatus 100 includes a power supply 10, a constant current circuit 20, a detection unit 30, a pulse width modulation (PWM) circuit 40, and an illumination unit 50. The illumination apparatus 100 may be used as a backlight module of a liquid crystal display.

The power supply 10 is used for providing a voltage to the constant current circuit 20, the detection unit 30 and the PWM circuit 40. The constant current circuit 20 is used for providing a constant current to the illumination unit 50. The detection unit 30 is used for detecting the brightness of the ambient light and generating a detecting signal according to the brightness of the ambient light. In the embodiment, when the brightness of the ambient light increases, the magnitude of the detecting signal increases, if the brightness of the ambient light decreases, the magnitude of the detecting signal decreases.

The PWM circuit 40 is used for generating a pulse voltage according to the detecting signal and the voltage of the power supply, when the magnitude of the detecting signal increases, the duty cycle of the pulse voltage increases. When the magnitude of the detecting signal decreases, the duty cycle of the pulse voltage is decreases.

The illumination unit 50 is used for emitting light according to the duty cycle of the pulse voltage of the PWM circuit 40. In the embodiment, when the duty cycle of the pulse voltage is increased, the luminous intensity of the illumination unit 50 is increased, and when the duty cycle of the pulse voltage is decreased, the luminous intensity of the illumination unit 50 is decreased.

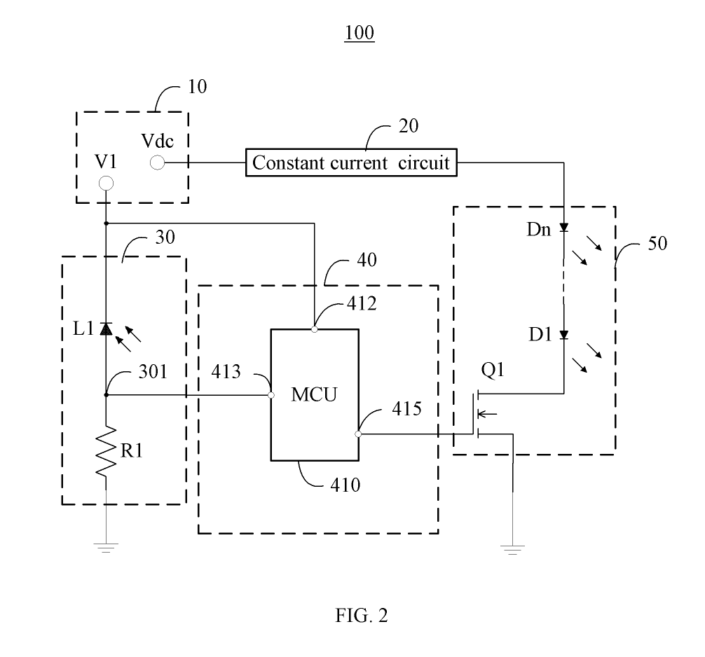

Referring to FIG. 2, the power supply 10 includes a first power terminal V1 and a second power terminal Vdc. The first power terminal V1 provides voltage to the detection unit 30 and the PWM unit 40. The second power terminal Vdc provides voltage to the constant current circuit 20.

The detecting unit 30 includes a photodiode L1, a node 301 and a resistor R1. The photodiode L1 is connected between the first power terminal V1 and the node 301. The first resistor R1 is connected between the node 301 and ground.

The PWM circuit 40 includes a micro control unit (MCU) 410. The MCU 410 includes a first pin 412, a second pin 413 and a third pin 415. The first pin 412 is connected to the first power terminal V1. The second pin 413 is connected to the node 301. The third pin 415 is connected to the illumination unit 50.

The illumination unit 50 includes a transistor Q1 and a plurality of light emitting diodes D1˜Dn. The plurality of the light emitting diodes D1˜Dn are connected with each other in series. The cathode of the first light emitting diode D1 is connected to a drain of the transistor Q1. The anode of the last light emitting diode Dn is connected to the constant current circuit 20. The cathode of the rest of the light emitting diodes is connected to the anode of the adjacent light emitting diode. The anode of the rest of the light emitting diodes is connected to the cathode of the adjacent light emitting diode. A gate of the transistor Q1 is connected to the third pin 415. A source of the transistor Q1 is grounded. The transistor Q1 is an n-channel enhancement type metal oxide semiconductor field effect transistor.

When the brightness of the ambient light is increased, the internal resistance of the photodiode L1 is decreased, such that the voltage of the node 301 increases. The voltage of the second pin 413 will be at the same voltage as the node 301 voltage. The duty cycle of the pulse voltage of the third pin 415 voltage is increased. The period in which the transistor Q1 is turned on is increased, such that the frequency of the D1˜Dn when turned on is increased. The luminous intensity of the illumination apparatus 100 is increased.

When the brightness of the ambient light is decreased, the internal resistance of the photodiode L1 is increased, the voltage of the node 301 decreases. The voltage of the second pin 413 will be at the same voltage as the node 301 voltage. The duty cycle of the pulse voltage of the third pin 415 decreases. The period in which the transistor Q1 is turned off is increased, such that the frequency of the D1˜Dn turned off is increased. The luminous intensity of the illumination apparatus 100 decreases.

A brightness adjusting method is used to adjusting the brightness of the illumination apparatus. The brightness adjusting method includes the following steps.

In step S201, generating a constant current.

In step S202, generating a detecting signal according to the ambient light, if the brightness of the ambient light is increased, the magnitude of the detecting signal increases. If the brightness of the ambient light is decreased, the magnitude of the detecting signal decreases.

In step S203, outputting a pulse voltage according to the detecting signal. When the magnitude of the detecting signal is increased, the duty cycle of the pulse voltage increases. When the magnitude of the detecting signal is decreased, the duty cycle of the pulse voltage decreases.

In step S204, emitting light according to the pulse voltage and the constant current. When the duty cycle of the pulse voltage is increased, the luminous intensity of the illumination apparatus increases. When the duty cycle of the pulse voltage is decreased, the luminous intensity of the illumination apparatus decreases.

Using the above brightness adjusting method, the illumination apparatus can adjust the luminous intensity according to the ambient light, thus the life of the illumination apparatus will increased. In addition, the illumination apparatus can protect the eye of the user.

It is to be understood, even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. An illumination apparatus adapted to emit light, the illumination apparatus comprising:
a detection unit adapted to detect brightness of ambient light and generate a detecting signal according to the brightness of the ambient light;
a pulse width modulation (PWM) unit adapted to supply a pulse voltage according to the detecting signal;
an illumination unit adapted to emit light according to the pulse voltage and a constant current
a power supply adapted to supply voltage to the detection unit, the PWM unit and the illumination unit; and
a constant current circuit connected between power supply and the illumination unit, the constant current circuit being adapted to supply the constant current to the illumination unit.

2. The illumination apparatus of claim 1, wherein when the brightness of the ambient light is increased, the magnitude of the detecting signal increases and the duty cycle of the pulse voltage increases, when the brightness of the ambient light is decreased, the magnitude of the detecting signal decreases and the duty cycle of the pulse voltage decreases.

3. The illumination apparatus of claim 1, wherein the detection unit comprises a photodiode and a resistor, the internal resistance of the photodiode changes according to the ambient light.

4. The illumination apparatus of claim 3, wherein the detection unit further comprises a node, the photodiode is connected between the power supply and the node, the resistor is connected between the node and ground, when the internal resistance of the photodiode is increased the voltage of the node decreases, when the internal resistance of the photodiode is decreased the voltage of the node increases.

5. The illumination apparatus of claim 1, wherein the PWM unit comprises a MCU, the MCU includes a first pin, a second pin and a third pin, the first pin is connected to the detection unit, the second pin is connected to the power supply, the third pin is connected to the illumination unit, the voltage of the first pin is the same as the node, the third pin output a pulse voltage according to the voltage of the node.

6. The illumination apparatus of claim 1, wherein the illumination unit comprises a plurality of light emitting diodes, the light emitting diodes are connected with each other in series, the cathode of the first light emitting diode is connected to the PWM unit, the anode of the last light emitting diode is connected to the constant current circuit, the cathode of the rest of the light emitting diode is connected to the anode of the adjacent light emitting diode, the anode of the rest of the light emitting diode is connected to the cathode of the adjacent light emitting diode.

7. The illumination apparatus of claim 6, wherein the illumination unit further comprises a transistor, a drain of the transistor is connected to the first light emitting diode, a gate of the transistor is connected to the PWM unit, and a source of the transistor is grounded.

8. The illumination apparatus of claim 7, wherein the transistor is an n-channel enhancement type metal oxide semiconductor field effect transistor.

9. The illumination apparatus of claim 1, wherein the power supply comprises a first power terminal and a second power terminal, the first power terminal provides voltage to the detection unit and the PWM unit, the second power unit provides voltage to the constant current circuit.

10. An illumination apparatus adapted to emit light, the illumination apparatus comprising:
a detection unit adapted to detect brightness of ambient light and generate a detecting signal;
a PWM unit adapted to output a pulse voltage according to the detecting signal; and
an illumination unit adapted to emit light according to the detecting signal.

11. The illumination apparatus of claim 10, wherein when the brightness of the ambient light is increased, the magnitude of the detecting signal increases and the duty cycle of the pulse voltage increases, when the brightness of the ambient light is decreased, the magnitude of the detecting signal decreases and the duty cycle of the pulse voltage decreases.

12. The illumination apparatus of claim 10, wherein the detection unit comprises a photodiode and a resistor, the photodiode and the resistor forms a voltage divider circuit, the internal resistance of the photodiode changes according to the ambient light.

13. The illumination apparatus of claim 10, wherein the illumination apparatus further comprises a power unit and a constant current circuit, the power supply further supplies voltage to the detection unit, the PWM and the illumination unit, the constant current circuit supplies a constant current to the illumination unit.

14. The illumination apparatus of claim 10, wherein the illumination unit comprises a plurality of light emitting diodes and a transistor, the light emitting diodes are connected with each other in series, the cathode of the first light emitting diode is connected to a drain of the transistor, the anode of the last light emitting diode is connected to a constant current circuit, the cathode of the rest of the light emitting diode is connected to the anode of the adjacent light emitting diode, the anode of the rest of the light emitting diode is connected to the cathode of the adjacent light emitting diode, a gate of the transistor is connected to the PWM unit, a source of the transistor is grounded.

15. A brightness adjusting method adapted to adjust the brightness of an illumination apparatus, the illumination apparatus comprising an illumination unit, and a constant current circuit adapted to supply a constant current to the illumination unit; the brightness adjusting method comprising:
generating a detecting signal according to the ambient light;
outputting a pulse voltage according to the detecting signal; and
the illumination units emitting light according to the pulse voltage.

16. The method according to claim 15, wherein when the magnitude of the detecting signal is increased, the duty cycle of the pulse voltage increases, the luminous intensity of the illumination apparatus increases.

17. The method according to claim 15, wherein when the magnitude of the detecting signal is decreased, the duty cycle of the pulse voltage decreases, the luminous intensity of the illumination apparatus decreases.
